(19) United States
(12) Patent Application Publication
(10) Pub. No.: US 2003/0070157 A1
(43) Pub. Date: Apr. 10, 2003

(54) Method and system for estimating software maintenance

(76) Inventors: John R. Adams, Sayre, PA (US); Kathleen D. Kear, Endicott, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/223,624

(22) Filed: Aug. 20, 2002

Related U.S. Application Data
(60) Provisional application No. 60/325,916, filed on Sep. 28, 2001.

(51) Int. Cl. G06F 9/44

(52) U.S. Cl. 717/101

(57) ABSTRACT

A method for estimating effort and cost to maintain a software application, group of applications or an aggregate system of applications entails determining a system size (in function points) and productivity level (in function points per hour or full-time equivalent). The productivity level takes into consideration the maintenance tasks to be performed as well as personnel attributes, such as capability and experience pertaining to the task. The effort equals the product of an effort multiplier and the system size divided by the productivity level. The effort multiplier takes into account maintenance complexities that may result in added effort and cost. The cost is determined by applying prevailing rates and fees to the calculated effort. As the maintained system is developed and enhanced, and as portions of the system are retired, the system size and productivity level are re-assessed and the effort and cost to maintain the system, as modified, are re-computed.

### RELATED APPLICATIONS

The present application claims the benefit of priority from copending provisional patent application No. 60/325,916 filed on Sep. 28, 2001, and which is hereby incorporated by reference in its entirety.

### FIELD OF THE INVENTION

The present invention relates to software metrics. More particularly, the present invention relates to a method for estimating the effort required to maintain software systems, particularly legacy systems.

### BACKGROUND

Maintenance, an integral phase of the software life cycle, entails providing user support and making changes to software (and possibly documentation) to increase value to users. Though software may require modifications to fix programming or documentation errors (corrective maintenance), maintenance is not limited to post-delivery corrections. Other changes may be driven by a desire to adapt the software to changes in the data requirements or processing environments (adaptive maintenance). Desires to enhance performance, improve maintainability or improve efficiency may also drive changes (perfective maintenance).

Performance of these tasks can be extremely expensive, often far exceeding the cost of original development. It is estimated that in large, long-lived applications, such as legacy systems, as much as 80% of the overall life cycle cost can accrue after initial deployment. Software applications, especially legacy systems, tend to evolve over time, undergoing many changes throughout their life cycles, and consuming substantial resources. For many companies and government agencies, software maintenance is a major cost, one that deserves careful management.

Effective management of software systems requires an accurate estimate of the level of resources (personnel and monetary resources) required for maintenance. Good estimates could aid both maintenance providers and customers in planning, budgeting, contracting and scheduling, as well as evaluating actual performance. However, despite the high cost of maintenance and its importance to the viability of a system, many managers have long relied on ad hoc estimates, based largely on their subjective judgment, educated guesswork and the availability of resources. Consequently, many companies have only a hazy idea of the size and complexity of their software, the level of resources required for maintenance and the productivity of maintenance providers. In this environment, neither maintenance providers nor customers have a way of quantifying, with reasonable certainty, the number of programmers and other resources needed to maintain a software system or the cost of continued maintenance. Without the necessary management information, cost overruns and missed deadlines become the norm rather than the exception.

Answering a need for software project management tools, various models and methodologies have emerged. Based on measurements of the project size as well as the capability of the programmer, such tools yield a level of effort, often in terms of staff-hours, such as FTEs (full time equivalents). Sizing may be based on a count of all source lines of code, function points (i.e., a measure of functionality based in part on the number of inputs, outputs, external inquiries, external logical files and internal logical files), or some other code features representative of size and complexity. While these models have proven useful, most have been designed primarily for use with managing the development of new software, and generally have very limited utility for software maintenance projects.

Models and methodologies proposed for measuring new software development cannot be readily generalized to software maintenance, because they do not take into account unique challenges of maintenance. For example, software applications, especially legacy systems, tend to evolve over time, undergoing many changes throughout their life cycles, each of which may dramatically impact maintainability. Most models are designed for evaluating an individual development project, rather than tracking and updating maintainability throughout the life cycle of a system. Additionally, many legacy systems no longer have (or may never have had) complete specifications or requirements, which are primary sources for determining a system size. Furthermore, legacy applications often contain many lines of “dead code,” which have been bypassed and/or disabled, but not removed. Legacy systems may also incorporate commercial-off-the-shelf (COTS) software, for which only executable code is available. Thus, it is difficult to obtain a meaningful and accurate count of the lines of code for such systems.

Other situations may further complicate maintainability, especially on legacy systems. For example, multiple development languages may have been used to create different applications within the system. In addition, currently available development tools may not support the languages that may be included. Also, the system may have an architecture dependent upon obsolete hardware, which may have become obsolete and been replaced or upgraded.

Though some methodologies have emerged to provide estimates for maintenance projects, they are quite limited. For example, they do not estimate the total cost of maintenance on an aggregate level for a landscape of legacy systems. They also do not adjust the baseline when modifications increase or decrease system size. Additionally, they tend to focus on a specific maintenance task (e.g., an adaptive maintenance project), rather than address the full range of maintenance tasks over the life cycle of a system. Furthermore, many of them require extensive historical systems data, which are often difficult and time-consuming, if even possible, to obtain.

### SUMMARY

The present invention provides a system and methodology as a tool for estimating the effort required to maintain software systems, particularly legacy applications, and subsequently measure and analyze changes in the system landscape.

It is therefore an object of the present invention to provide a system and method for estimating the effort and cost for maintaining a software application, group of applications and/or an aggregate system of applications.

It is also an object of the invention to provide a system and method for estimating the effort and cost for maintaining a software application, group of applications and/or an aggregate system of applications wherein the system and method take into account the maintained system size and a maintenance productivity level based on personnel capabilities and experience.

It is another object of the invention to provide a system and method for estimating the effort and cost for maintaining a software application, group of applications and/or an aggregate system of applications wherein the system and method take into account maintenance complexities that may result in added effort and cost.

It is also another object of the invention to provide a system and method for estimating the effort and cost for maintaining a software application, group of applications and/or an aggregate system of applications wherein the system and method take into account changes in maintained size and changes in maintenance productivity level over time.

It is still another object of the invention to provide a system and method for estimating the effort and cost for maintaining a software application, group of applications and/or an aggregate system of applications wherein the system and method employ an initial system size in function points derived from a source lines of code count and empirical data.

It is a further object of the invention to provide a system and method for estimating the effort and cost for maintaining a software application, group of applications and/or an aggregate system of applications wherein the system and method takes into account customer support as well as adaptive, corrective and perfective maintenance.

It is a yet another object of the invention to provide a system and method for estimating the effort and cost for maintaining a software application, group of applications and/or an aggregate system of applications wherein a plurality of funding methodologies are provided to facilitate funding of maintenance and related activities.

To accomplish these and other objects of the present invention, a system and method are provided for estimating effort and cost to maintain a software application, group of applications or an aggregate system of applications (each of which is referred to herein as a “system”). A system size and productivity level are determined. The productivity level preferably takes into consideration the maintenance tasks to be performed as well as personnel attributes, such as capability and experience pertaining to the task. The effort equals the product of an effort multiplier and the system size divided by the productivity level. The effort multiplier preferably takes into account maintenance complexities that may result in added effort and cost. The cost is determined by applying prevailing rates and fees to the calculated effort. As the maintained system is developed and enhanced, and as portions of the system are retired, the system size and productivity level are reassessed and the effort and cost to maintain the system as modified are re-computed.

### BRIEF DESCRIPTION OF THE DRAWINGS

The foregoing and other objects, features and advantages of the present invention will become better understood with reference to the following description, appended claims, and accompanying drawings, where:

FIG. 1 is a high-level block diagram of an exemplary computer system that may be used to estimate application maintenance in accordance with a preferred embodiment of the present invention;

FIG. 2 is a flowchart of exemplary steps of a sustainment baseline path in accordance with a preferred implementation of the present invention;

FIG. 3 is a table of exemplary productivity factors correlated with scopes of maintenance activities and maturity levels in accordance with a preferred implementation of the present invention;

FIGS. 4A-4R are tables of exemplary risk factors (ratings) as a function of maintenance system attributes and sub-attributes in accordance with a preferred implementation of the present invention;

FIGS. 5A-5D are tables of explanations of relationships between maintenance system attributes and ratings and relative COCOMO cost drivers, as in FIGS. 4A-4R, in accordance with a preferred implementation of the present invention;

FIGS. 6A-6E are tables of exemplary weights for sub-attributes in accordance with a preferred implementation of the present invention;

FIGS. 7A-7C are tables illustrating an exemplary calculation of an effort multiplier for a hypothetical system in accordance with a preferred implementation of the present invention;

FIG. 8 is a table of exemplary COCOMO II personnel attribute cost drivers for use in determining an effort adjustment factor in accordance with a preferred implementation of the present invention;

FIG. 9 is a flowchart of exemplary steps of a develop-enhance-retire path in accordance with a preferred implementation of the present invention; and

FIG. 10 provides a table of exemplary productivity ratios for use in calculating a productivity level in accordance with a preferred implementation of the present invention.

FIG. 11 is a flowchart of the overall steps in an implementation of the present invention.

### DETAILED DESCRIPTION

The present invention provides a system and method for estimating effort and cost to maintain a software application, group of applications or an aggregate system of applications (each of which is referred to herein as a “system”). A system size and productivity level are determined. The productivity level preferably takes into consideration the maintenance tasks to be performed as well as personnel attributes, such as capability and experience pertaining to the task. The effort equals the product of an effort multiplier and the system size divided by the productivity level. The effort multiplier preferably takes into account maintenance complexities that may result in added effort and cost. The cost is determined by applying prevailing rates and fees to the calculated effort. As the maintained system is developed and enhanced, and as portions of the system are retired, the system size and productivity level are reassessed and the effort and cost to maintain the system as modified are re-computed.

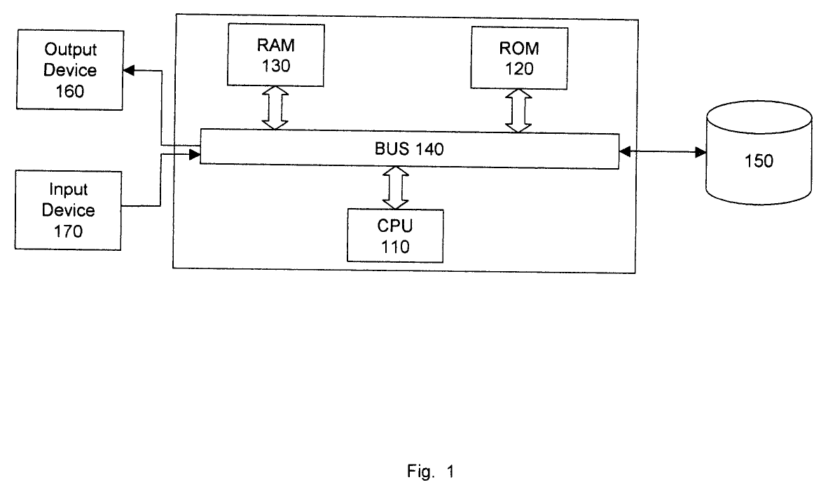

The present invention is preferably implemented on a programmed computer, though implementation without a computer is feasible and within the scope of the invention. Referring to FIG. 1, an exemplary computer system for use in estimating application maintenance in accordance with the present invention preferably includes a central processing unit (CPU) 110, read only memory (ROM) 120, random access memory (RAM) 130, a bus 140, a storage device 150, an output device 160 and an input device 170. The storage device may include a hard disk, CD-ROM drive, tape drive, memory and/or other mass storage equipment. The output device may include a display monitor, a printer and/or another device for communicating information. These elements are typically included in most computer systems and the aforementioned system is intended to represent a broad category of systems that may be programmed to receive input, manage data, perform calculations and provide output in accordance with steps of the methodology of the present invention. Of course, the system may include fewer, different and/or additional elements. Additionally, the system may either stand alone or operate in a distributed environment.

A preferred implementation of the methodology of the present invention includes three paths: a sustainment baseline path, a fast path and a develop-enhance-retire path. The sustainment baseline path determines the required effort hours (in FTEs) and cost to sustain a system. The fast path manages an established pool of available effort hours for use by a customer on desired activities. The develop-enhance-retire path accounts for changes in system size caused by new development, enhancement and retirement activities.

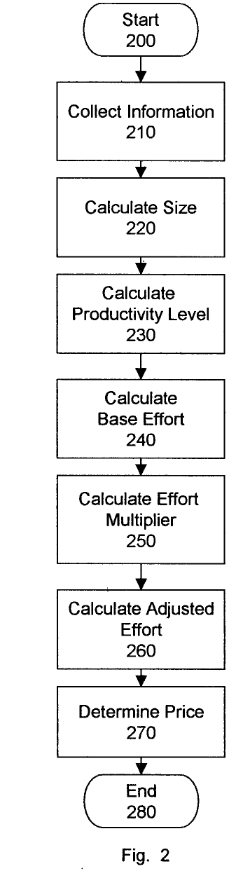

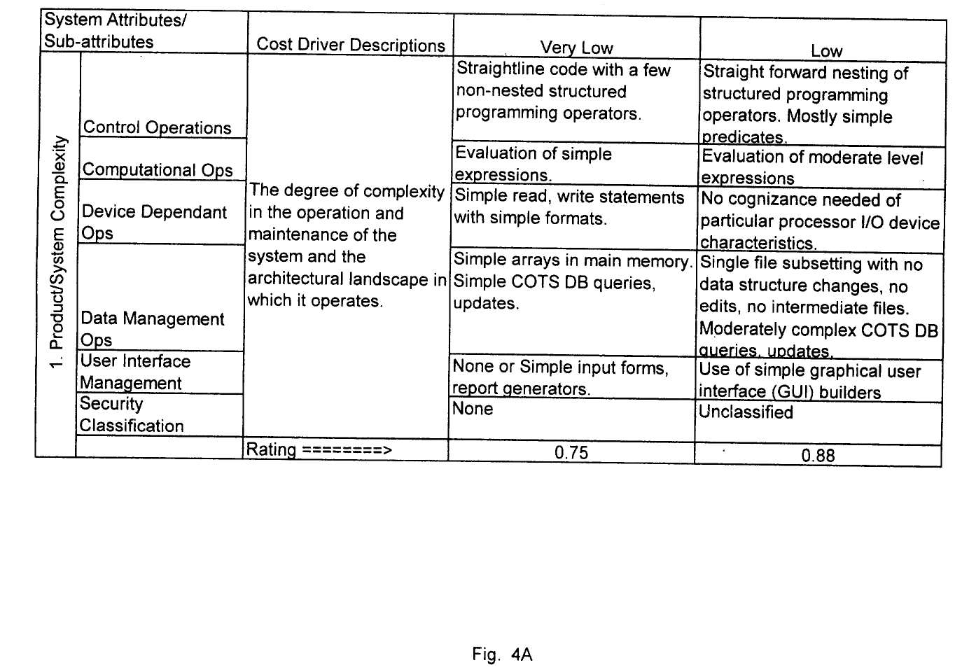

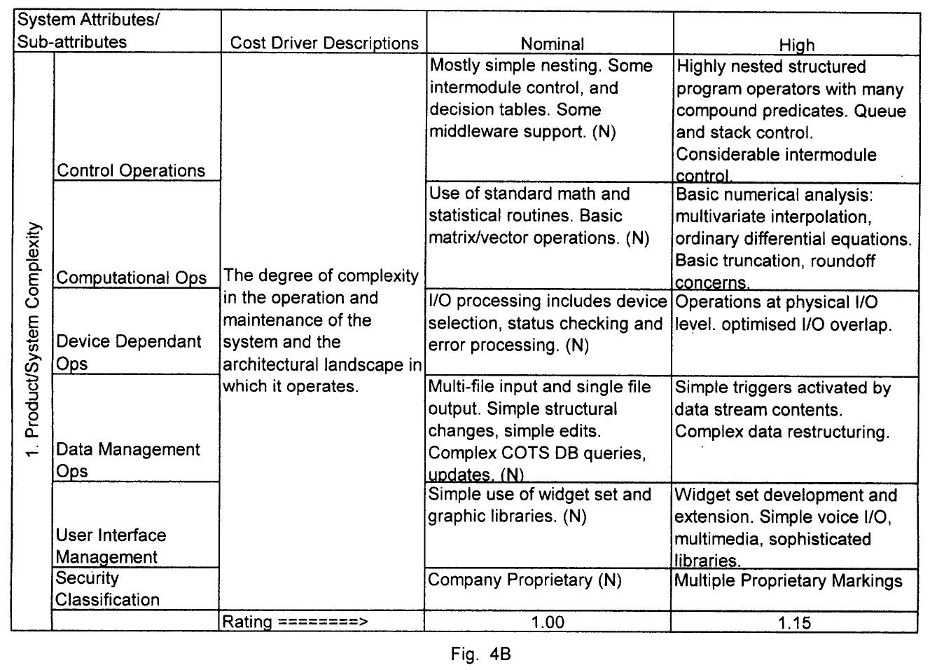

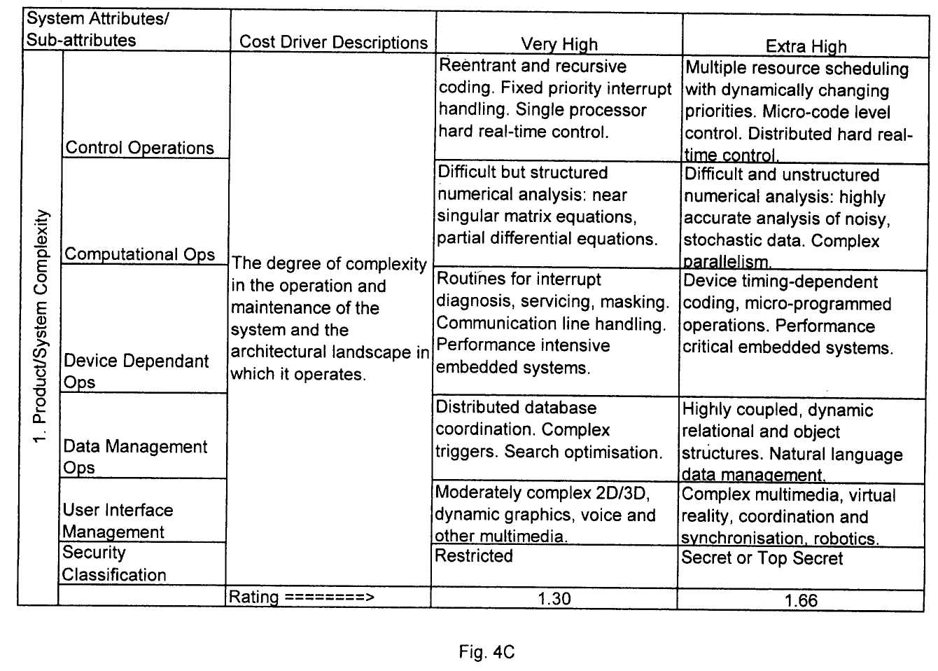

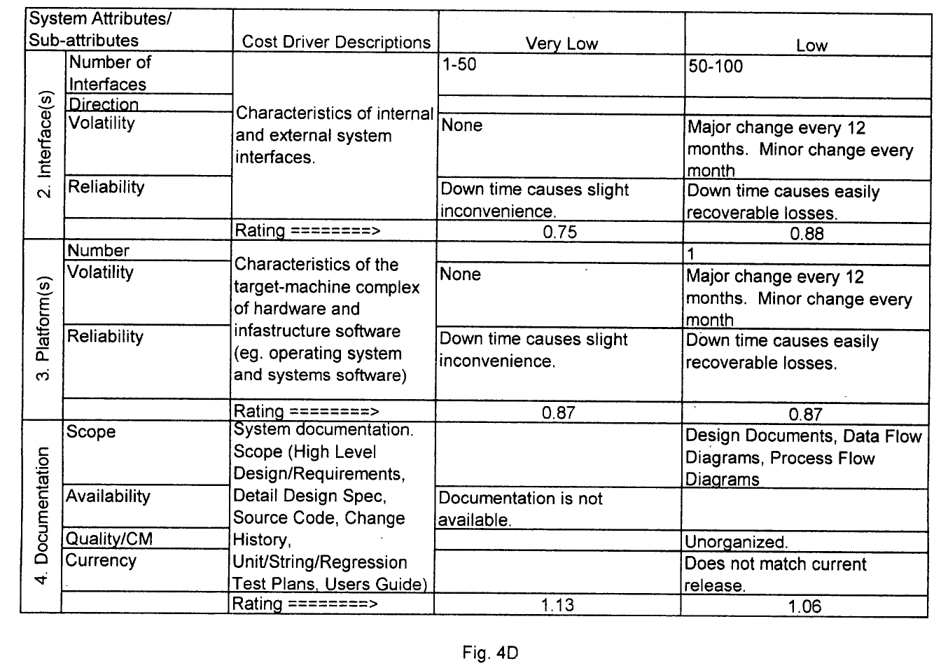

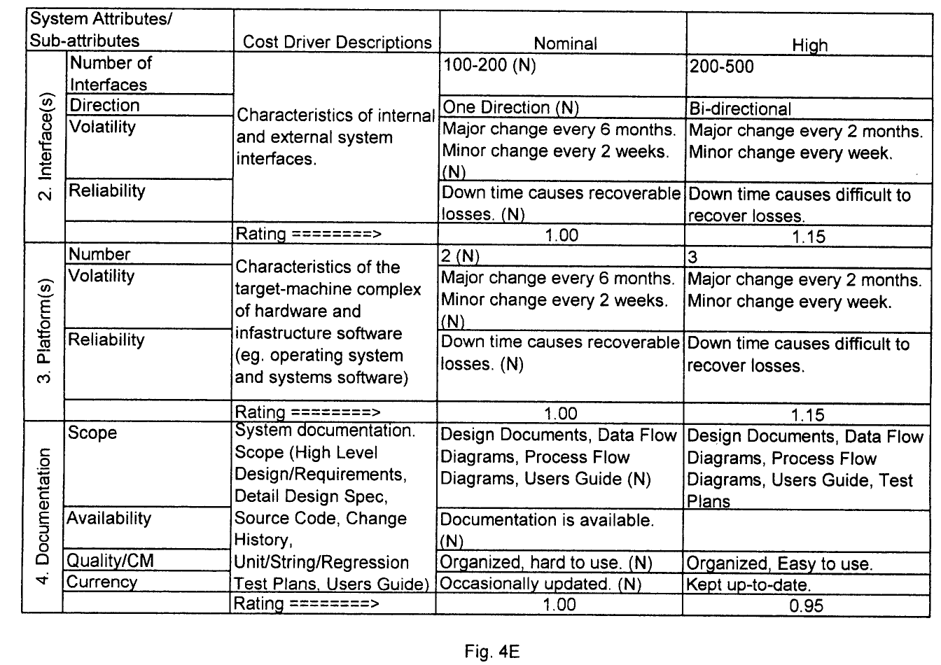

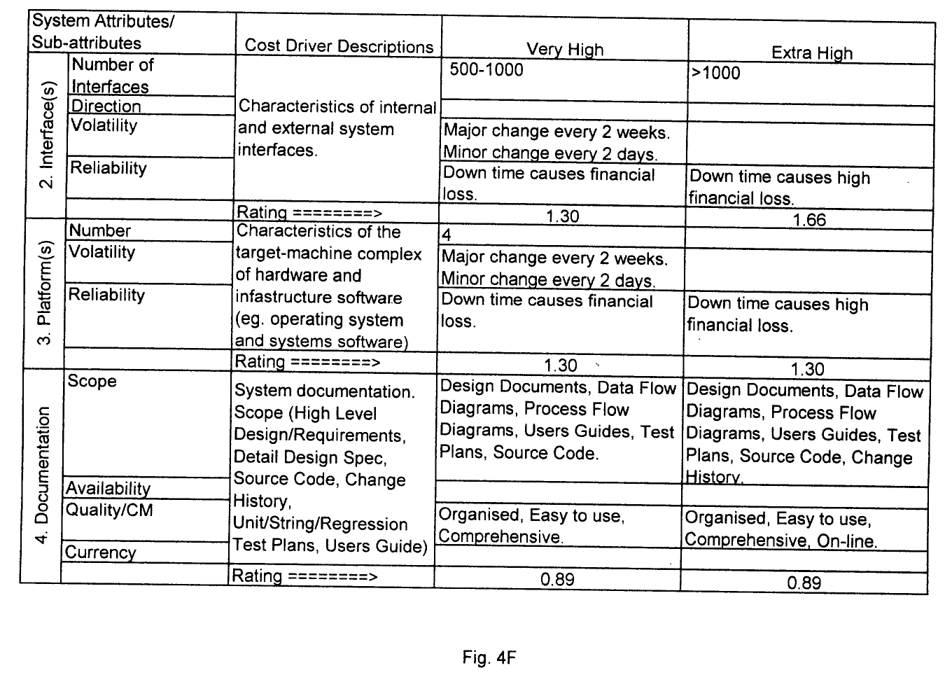

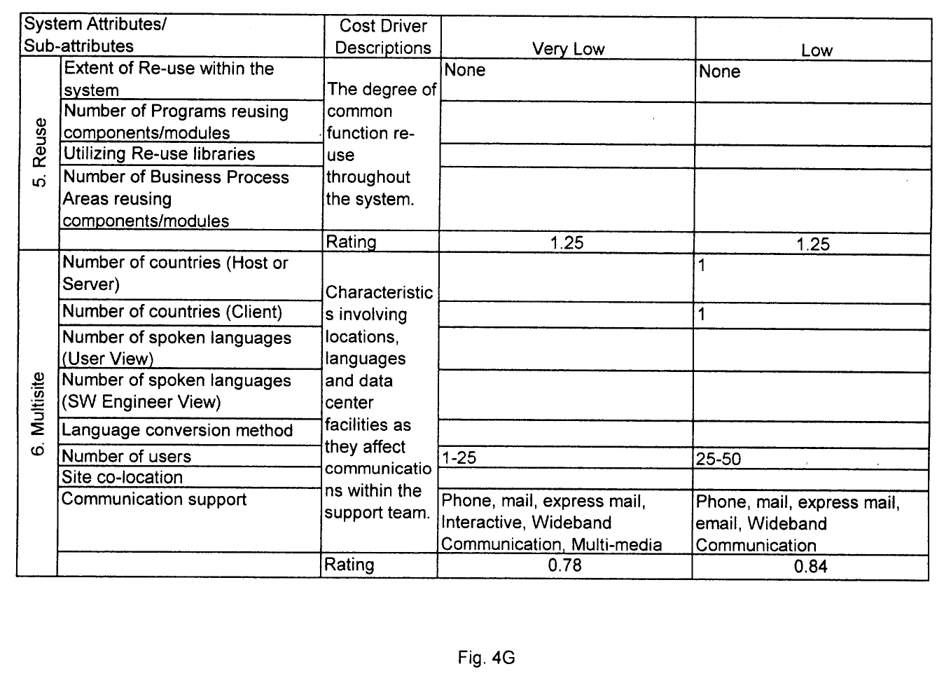

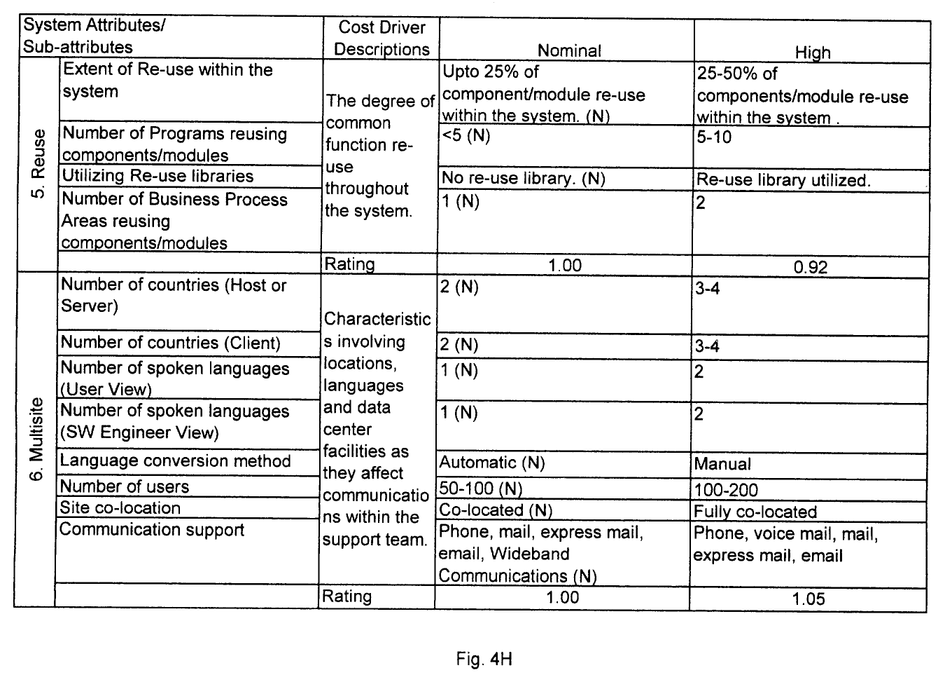

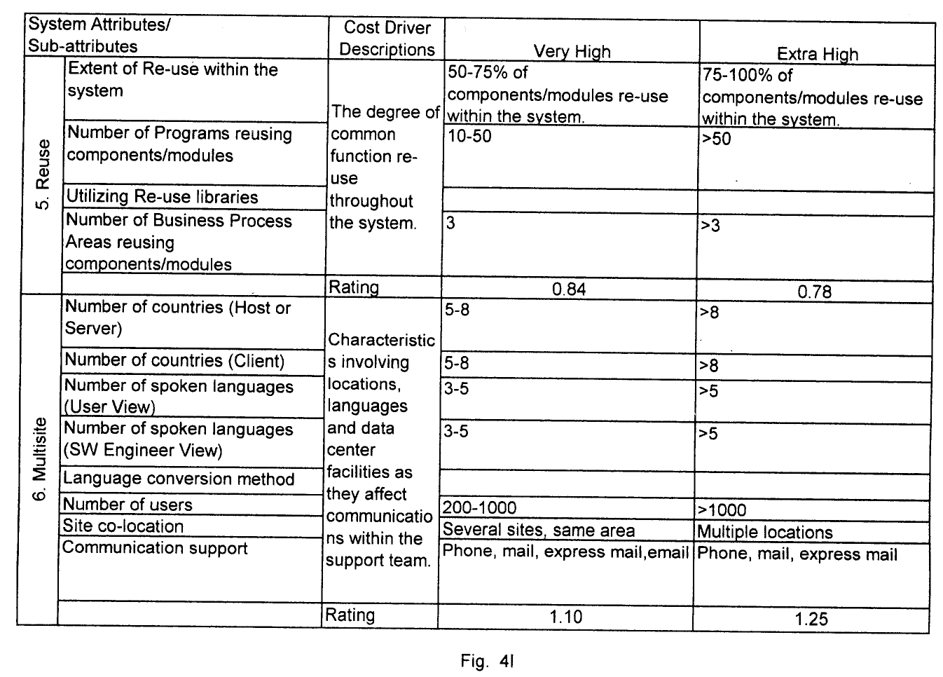

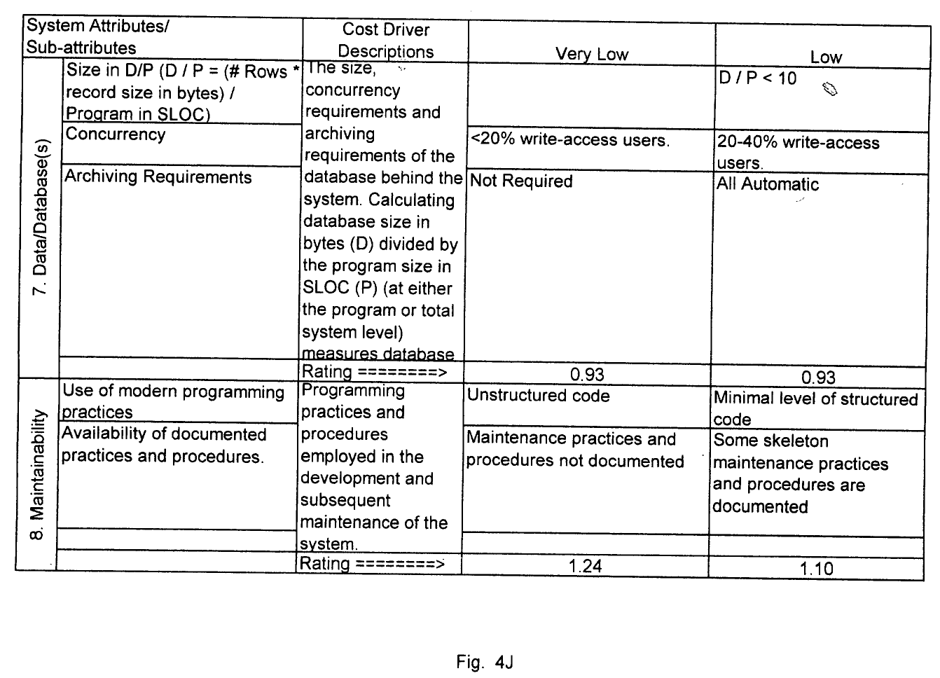

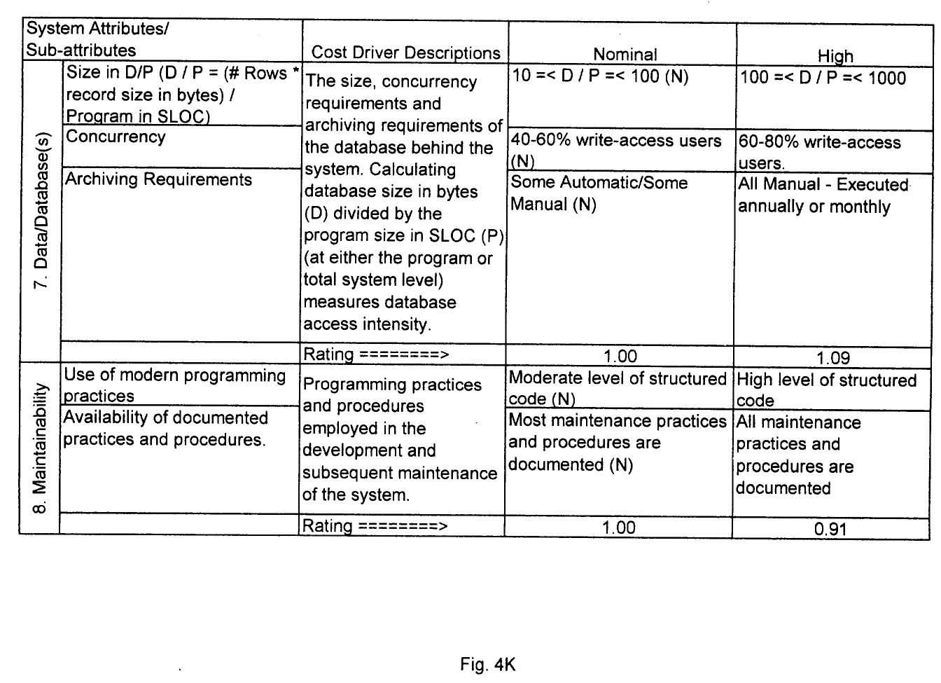

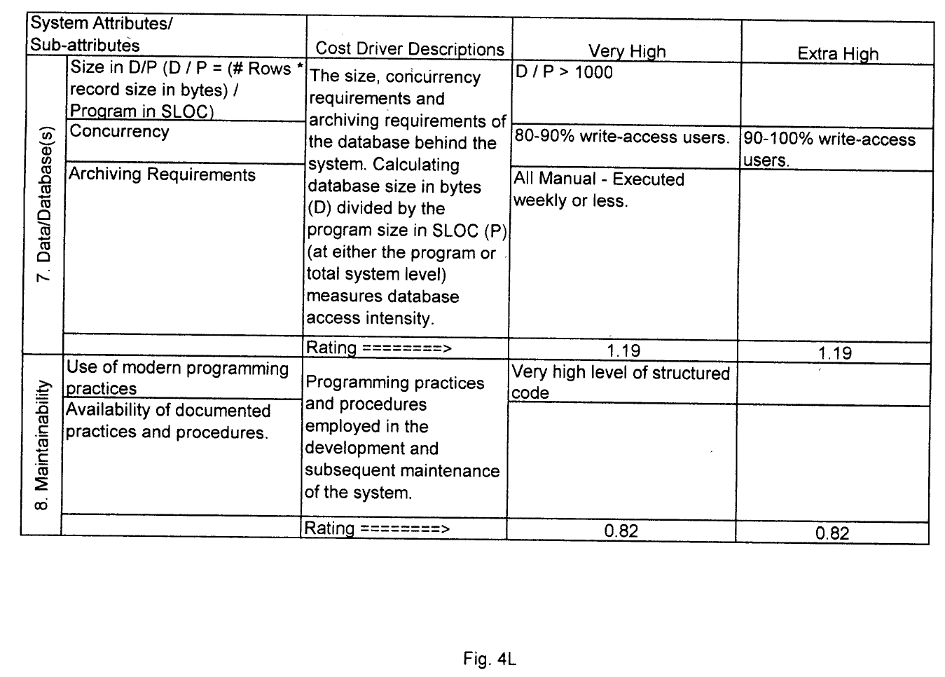

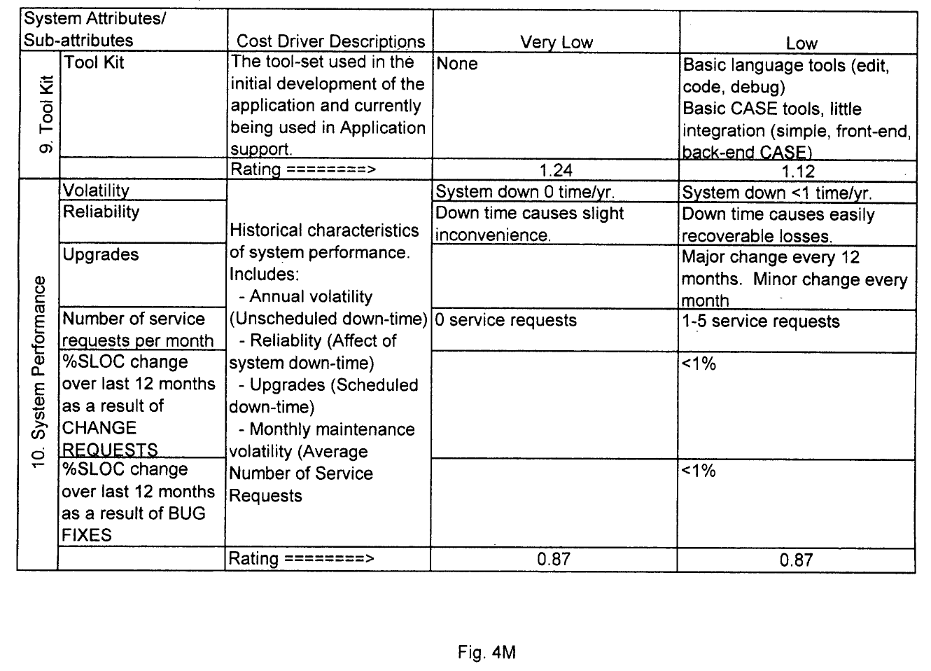

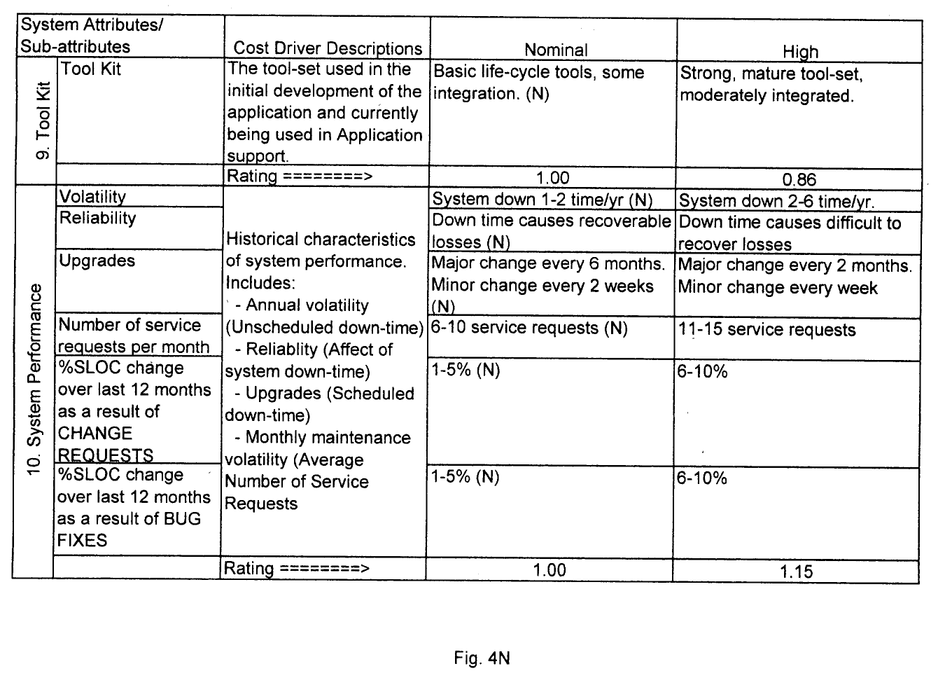

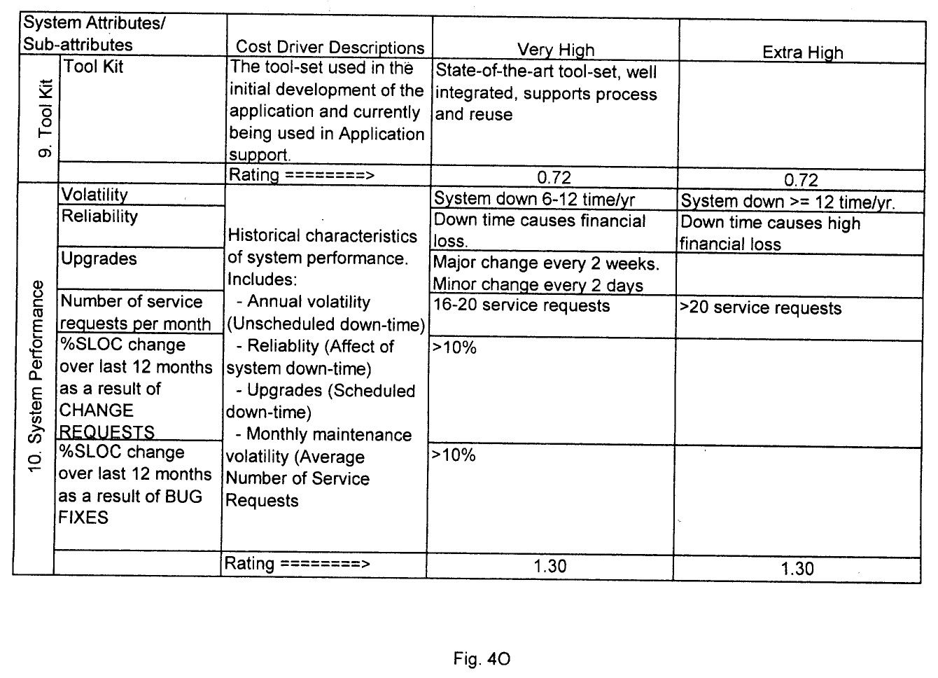

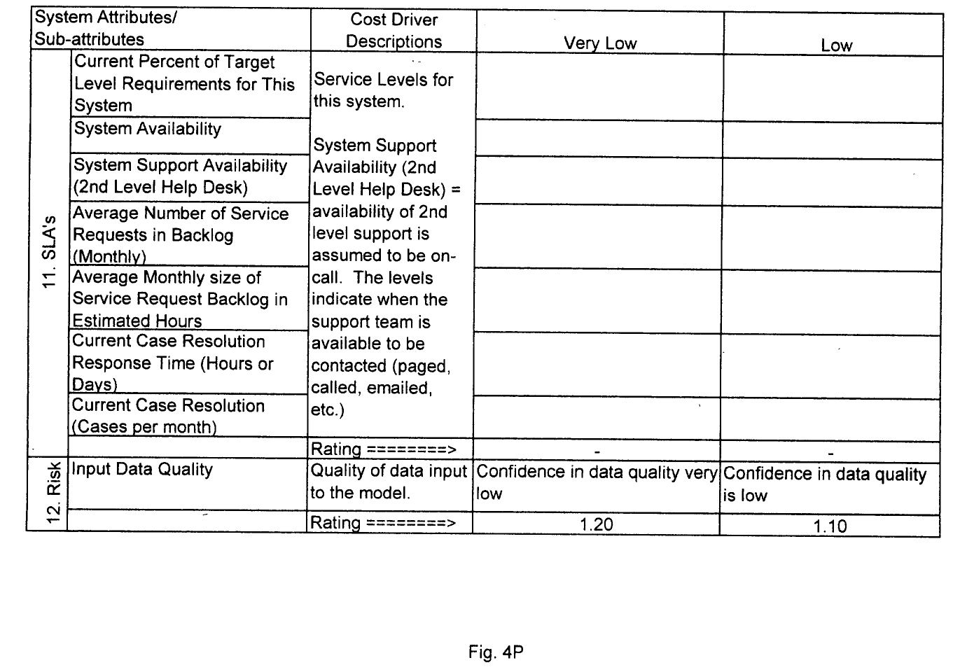

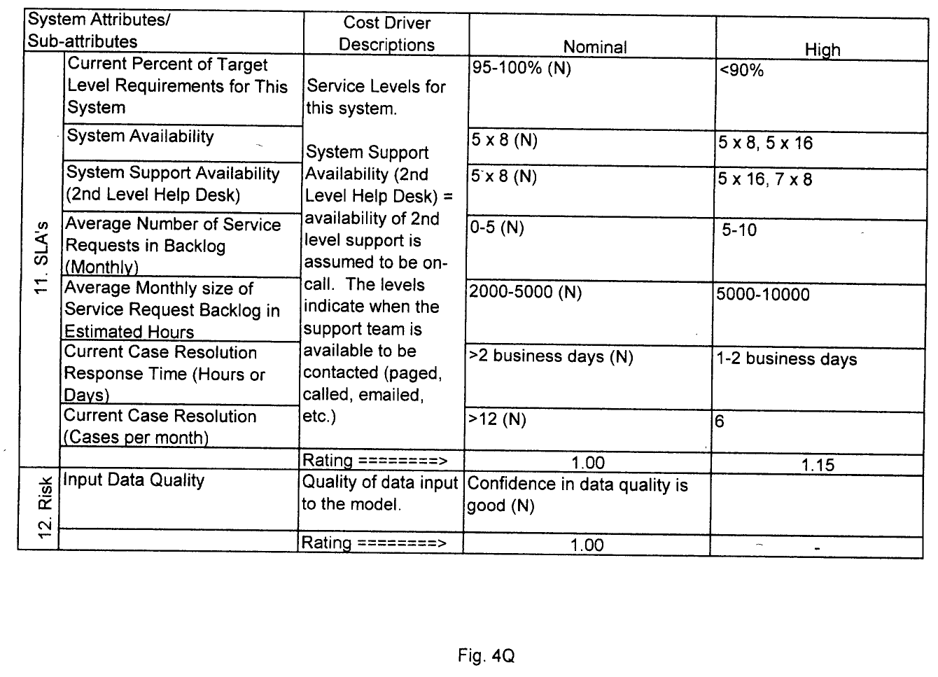

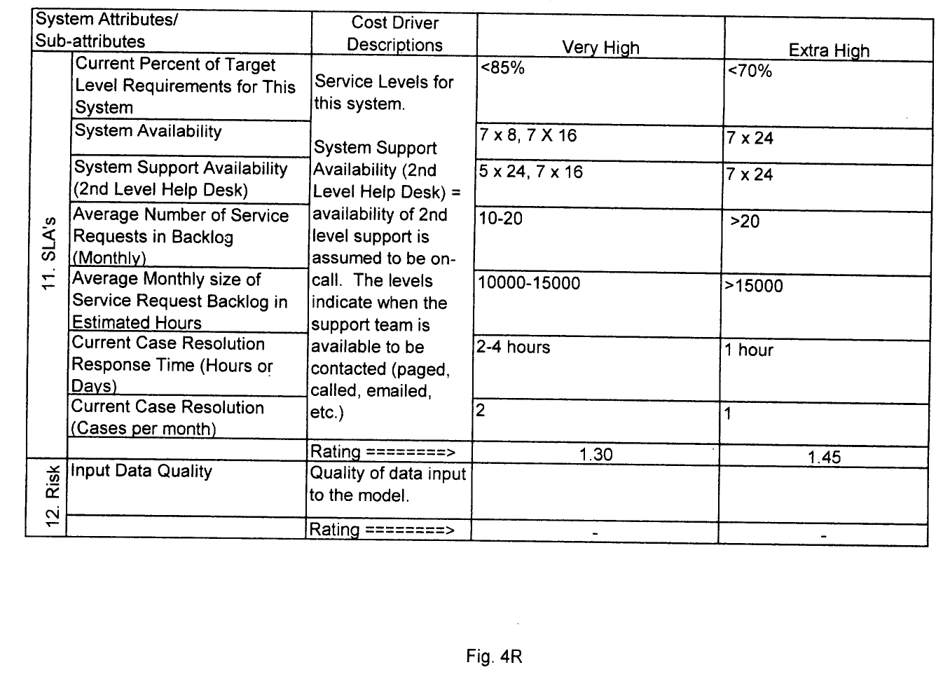

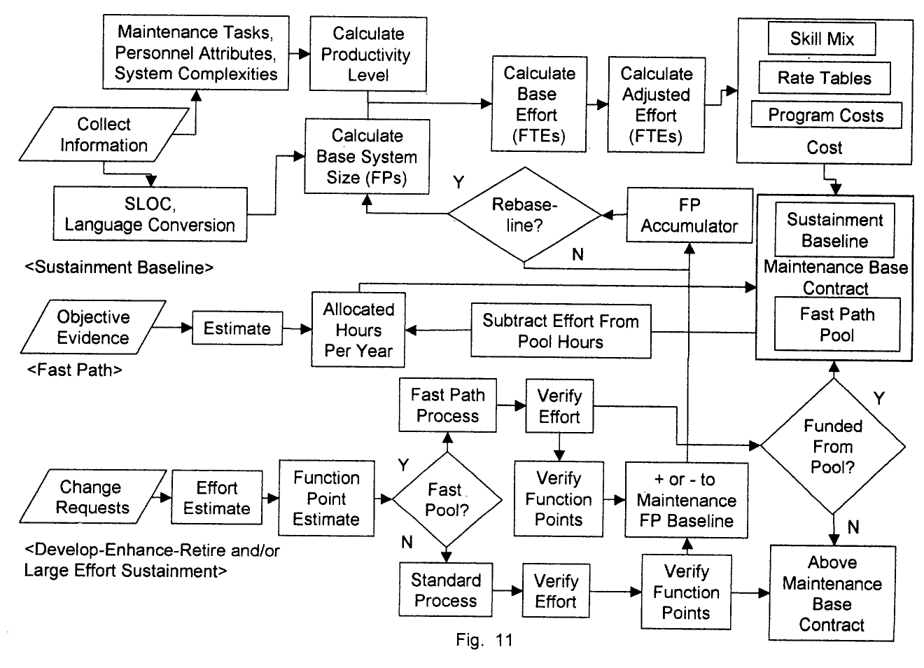

An implementation of the present invention includes a sustainment baseline path (see FIG. 2 and FIG. 11). This path includes seven steps, the first of which, step 210, is the collection of information required for determining the system size and maintenance effort. The information may be obtained through a structured survey and investigation. Preferably, the information includes a count of the source lines of code by program language for the system, the system owner, the system name, the system type, and descriptions of COTS products and database management systems (DBMS) included in or in use with the system. The information also preferably includes sufficient details concerning the maintenance system attributes and sub-attributes, such as those identified in the left two (first and second) columns of FIGS. 4A-4R, so as to facilitate an accurate assessment of complexity and a corresponding rating for each sub-attribute. The attributes may include:

1. Product/System Complexity—The degree of complexity in the operation and maintenance of the system and the architectural landscape in which it operates. Sub-attributes may include: control operations, computational operations, device dependant operations, data management operations, user interface management, and security classification.

2. Interfaces—The characteristics of internal and external system interfaces. Sub-attributes may include: number of interfaces, direction, volatility and reliability.

3. Platforms—The characteristics of the target-machine, complex of hardware and infrastructure software. Sub-attributes may include: number, volatility and reliability.

4. Documentation—The scope of the system documentation, including high level design and requirements, detail design specifications, source code, change history, test plans and user guides. Sub-attributes may include: scope, availability, quality and comprehensiveness and currency.

5. Reuse—The degree of common function re-use throughout the system. Sub-attributes may include: extent of re-use within system, number of programs re-using components/modules, use of re-use libraries, number of business process areas reusing components/modules.

6. Multisite—Characteristics involving locations, languages and data center facilities as they affect communications within the support team. Sub-attributes may include: number of countries (host/server), number of countries (client), number of spoken languages (user), number of spoken languages (software engineer), language conversion method (auto/manual), number of users, site co-location and communications support.

7. Data/Databases—The size, concurrency requirements and archiving requirements of a database behind the system. Sub-attributes may include: database access intensity level, concurrency and archiving requirements.

8. Maintainability—Programming practices and procedures employed in the development and subsequent maintenance of the system. Sub-attributes may include: use of modern programming practices and availability of documented practices and procedures.

9. Tool Kit—Strength and maturity of the tool-set used in the initial development of the application and currently being used in application support.

10. System Performance—Historical characteristics of system performance. Sub-attributes may include: annual volatility (unscheduled downtime), reliability (effect of system downtime), upgrades (scheduled downtime), monthly maintenance volatility (average number of service requests per month), maintenance volatility that affects SLOC (% annual SLOC changes due to change requests and bug fixes).

11. Service Level Agreements (SLAs)—Service levels for the system in terms of system support availability. Sub-attributes may include: system availability, system support availability, average number of service requests in backlog (monthly), average size (in hours) of service request backlog (monthly), current case resolution response time and current average number of cases resolved per month.

Other information collected in step 210 may include, if available, the specifications and requirements for a system.

After collecting the required information, the system size is calculated, as in step 220, preferably in terms of function points. Function points are a measure of the size of an application in terms of its functionality. Function point counting techniques, several of which are well known in the art, generally entail tallying system inputs, outputs, inquiries, external files and internal files. The information is typically obtained from detailed specifications and functional requirements documentation for the system being measured. Each tallied item is weighted according to its individual complexity. The weighted sum of function points is then adjusted with a multiplier, decreasing, maintaining or increasing the total according to the intricacy of the system. The multiplier is based on various characteristics that evidence intricacy, such as complex data communications, distributed processing, stringent performance objectives, heavy usage, fast transaction rates, user friendly design and complex processing. While there are several evolutions, variations and derivatives of Function point counting techniques, the International Function Point User Group (IFPUG) publishes a widely followed and preferred version in its “Function Point Counting Practices Manual.”

An important aspect of the present invention is that an initial system size may be determined without need for requirements, specifications or extensive historical systems data. For initial system sizing, the methodology of a preferred implementation of the present invention employs a technique known as “backfiring” to convert source lines of code (SLOC) for each programming language into function point equivalents. Backfiring facilitates sizing where conventional function point counting would be difficult or impossible. For example, many legacy systems no longer have complete specifications or requirements, which are primary sources for determining function point inputs, outputs, inquiries, external files and internal files. In such circumstances, conventional function point counting can be extremely impractical.

Using the backfire methodology and a programming language conversion table, source lines of code may be converted into function point equivalents for each programming language utilized. Such tables typically provide conversion factors based on historical evidence, and may take into account system size and complexity. For example, a table may equate 107 average complexity Cobol source lines of code with one function point, and 53 average complexity C++ source lines of code with one function point. While several such tables are available, the preferred resource for backfiring average complexity coding is in “Estimating Software Costs,” Jones, T. Capers, McGraw-Hill, New York, N.Y. 1998, as well as at http://www.spr.com/library/0langtbl.htm by Software Productivity Research, Inc. of Burlington, Mass.

Backfiring normalizes the data to a common point of reference so that equal comparisons can be performed across various systems with diverse coding languages. The product is a system size in function points that may take into consideration the complexity of a system. The accumulation of these sizes, in function points, for all languages associated with a system results in the initial system size in function points.

As initial system size in function points is a key measurement of the process, the SLOC count, which will be converted to function points via backfiring, is also a key measurement. If the initial SLOC count is inaccurate, the function point results will not be accurate.

Two prevailing Source Lines of Code (SLOC) definitions available for use by the invention are referred to as physical and logical SLOCs. The physical SLOC definition is based on Dr. Barry W. Boehm's deliverable source instruction (DSI), i.e., non-blank, non-comment, physical source-level lines of code, as described in “Software Engineering Economics,” Boehm, Barry W., Prentice Hall 1981. The logical SLOC definition is based on logical statements and will vary across programming languages due to language-specific syntax. Preferably, SLOCs are counted using logical language statements per Software Engineering Institute (SEI) guidelines, as set forth in Park, R., “Software Size Measurement: A Framework for Counting Source Statements,” CMU/SEI-92-TR-20, Software Engineering Institute, Pittsburgh, Pa., 1992. In general, the logical SLOC count includes all program instructions and job control lines, but excludes comments, blank lines, and standard include files. User-defined include files count once for logical SLOC counts. A logical line of code is not necessarily a physical line.

A significant aspect of the present invention is that after the initial system sizing, sizes of new modifications may be determined using IFPUG function point standards, without backfiring. Preferably, such modifications will include complete documentation with specifications and requirements, making a conventional function point count for the modifications feasible. The change, in function points, is added or subtracted from the baseline. Over time, the modifications may comprise a substantial portion of the system, diluting the effect of any sizing inaccuracies introduced by backfiring.

It should be understood that the system size may change (increase or decrease) as the system is modified. The system size prevailing at a given time is referred to herein as the base system size.

Another important aspect of the present invention is that it accounts for the productivity of maintenance staff, based in part on historical data. After determining a base system size, as in step 220, a maintenance productivity level is calculated, as in step 230. The productivity level is expressed as the number of function points a maintenance programmer or a full time equivalent (FTE) can support. A full time equivalent equals the full time service of one person for a given period of time. The maintenance productivity level is based on the personnel capability and/or process maturity of a maintenance organization, along with the definition of the scope of maintenance.

One technique for calculating a historical maintenance productivity level involves dividing the base system size, as determined in step 220, by the actual number of FTEs currently supporting the measured system, as follows:

$$Productivity Level = \frac{Base System Size}{FTEs Supporting System}$$

A second technique for calculating a maintenance productivity level, which is preferred, involves calculating a net maintenance productivity ratio and applying a COCOMO II-based effort adjustment factor. The original COCOMO constructive cost model, first presented by Dr. Barry Boehm in “Software Engineering Economics,” Prentice Hall, Englewood Cliffs, N.J., 1981, provided a structured methodology for estimating cost, effort and scheduling in planning new software development activities. COCOMO II, a revised model, emerged to reflect changes in professional software development practice since the original model.

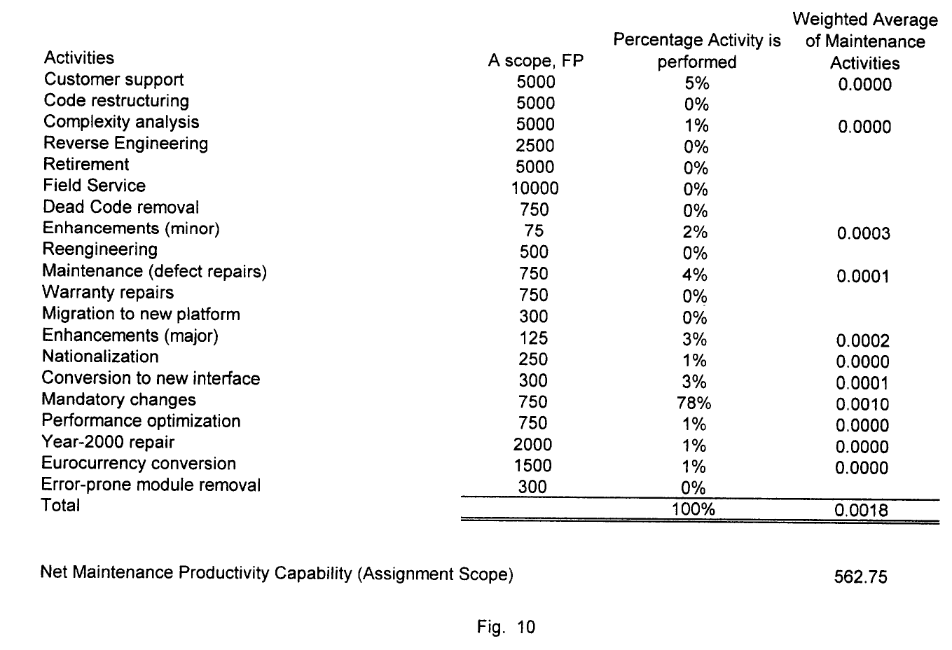

To calculate the productivity level, average productivity ratios (FP/FTE) are applied to the maintenance tasks comprising the maintenance effort. FIG. 10 provides a table of such productivity ratios based on Jones, T. Capers, “Estimating Software Costs,” McGraw Hill, New York, N.Y., 1998, Table 27.3, p.600. The first column identifies common maintenance tasks. The second column provides, as a productivity ratio, the number of function points one FTE (e.g., a maintenance programmer at 152 hours per month) can handle for the task.

The average productivity ratios are then weighted, according to the estimated percentage each task will comprise of the total maintenance effort, as shown in the third column of FIG. 10. Then, weighted averages (column 4) are calculated by dividing the percentage (column 3) by the average productivity ratio (column 2), as shown in FIG. 10. Next, the weighted averages are summed. The net maintenance productivity ratio equals the inverse of the sum of the weighted averages.

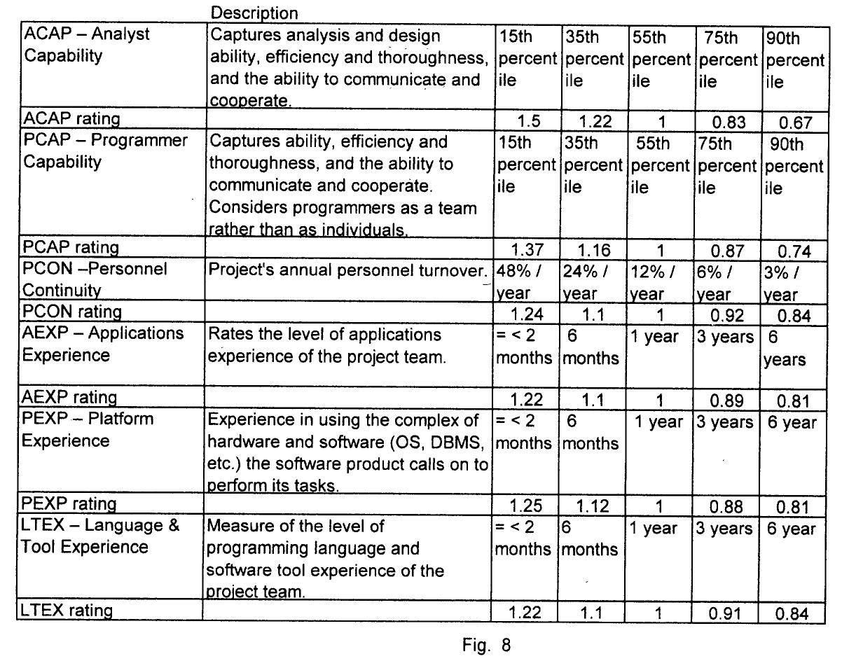

Finally, the net maintenance productivity ratio is divided by a COCOMO II-based effort adjustment factor, resulting in the maintenance productivity level. The effort adjustment factor (EAF) is determined based on COCOMO II personnel attribute cost drivers, as shown in FIG. 8. The effort adjustment factor equals the product of the applicable effort ratings for the personnel cost drivers. Effort multipliers may be determined via interpolation or extrapolation for percentiles not provided in the table.

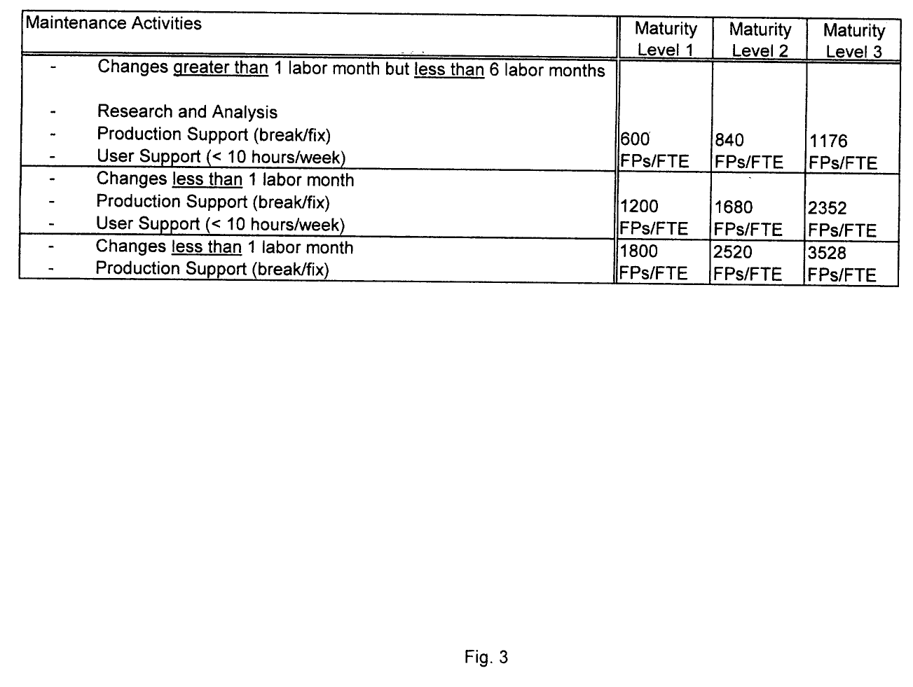

A third technique for calculating a maintenance productivity level involves correlating productivity levels with the size of the maintenance task and the maturity level of an organization. The Capability Maturity Model for Software (CMM), developed by the Carnegie Mellon Software Engineering Institute, provides a preferred model for judging the maturity of the software process. Each maturity level of the CMM corresponds to an evolutionary plateau toward achieving a mature software process. Referring to FIG. 3, by determining the scope of maintenance activities (left column) and the maturity level of an organization (columns 2, 3 & 4), a productivity level, which is based on historical evidence, can be determined.

After the productivity level is calculated, a base effort (e.g., in FTEs) is calculated, as in step 240, by dividing the base system size (e.g., in function points) by the productivity level (e.g., in function points per FTE), as follows:

$$Base Effort = \frac{Base System Size}{Productivity Level}$$

Another important feature is that, using an effort multiplier, the present invention accounts for maintenance complexities which may demand more than the average effort for a system of a given size and a maintenance staff having a certain productivity level. The effort multiplier is determined for adjusting the base FTE count to provide a more accurate representation of the total maintenance effort, as in step 250. The effort multiplier operates as a risk factor, allocating more effort to account for maintenance complexities. For example, maintaining a complex system, with many critical interfaces, without any documentation and all other attributes being average, would warrant an effort multiplier greater than one. Alternative approaches for determining an effort multiplier to capture such external factors include a risk allowance approach and a risk driven approach.

The risk allowance approach establishes an effort multiplier based on the amount of risk a user of the present invention is willing to accept. For example, a maintenance provider may want to allow for a 10% risk to account for additional effort required based on maintenance complexities. In such case, the effort multiplier would be 1.1, i.e., the amount of risk added to one. This would increase the estimated effort (and consequently price) to maintain a system. A zero percent risk would result in an effort multiplier of one, which would neither increase nor decrease the estimated effort to maintain the system. The table below provides risk amounts as a function of effort multipliers.

| Risk Amount | Effort Multiplier |
|---|---|
| 0% | 1.0 |
| 5% | 1.05 |
| 10% | 1.1 |
| 20% | 1.2 |
| 30% | 1.3 |

The risk driven approach uses ratings and weights, determined by evaluating maintenance system properties and accounting for maintenance complexities, to compute an effort multiplier. Complex maintenance systems, according to the attributes and sub-attributes addressed in the first two columns of FIGS. 4A-4R, typically result in additional efforts that add cost, but are beyond the SLOC count used for initial system sizing.

The attributes (left/first column with vertical text numbered 1 through 12), sub-attributes (second column, adjacent to attributes) and ratings (last row for each attribute) in FIGS. 4A-4R have been tailored to reflect software maintenance, rather than new software development. They address various maintenance cost drivers, including system complexity, size of databases, availability and quality of documentation, volatility of interfaces and platforms, communication between multiple system sites, maintainability as a result of development programming practices, availability of tool kits, amount of reuse, and volatility of system performance. Of course, other maintenance system attributes, sub-attributes and/or corresponding ratings representative of a maintenance cost driver may be employed in addition to, or in lieu of, some or all of the attributes, sub-attributes and/or corresponding ratings provided in FIGS. 4A-4R, without departing from the scope of the present invention.

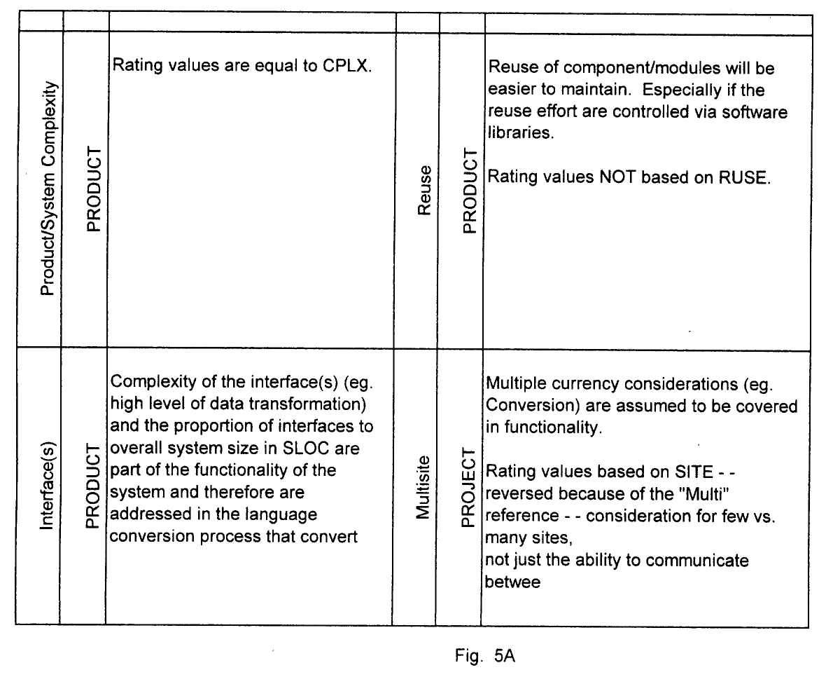

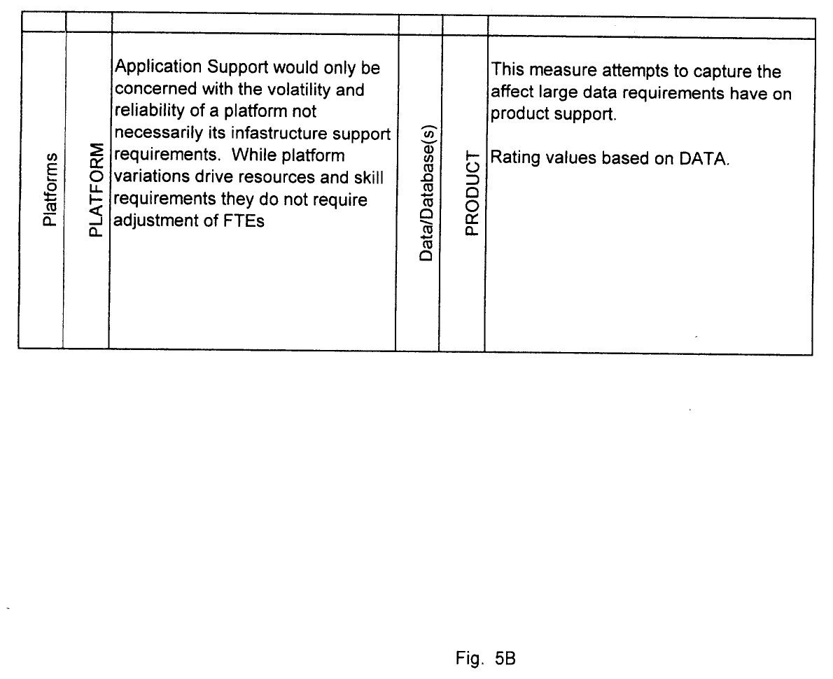

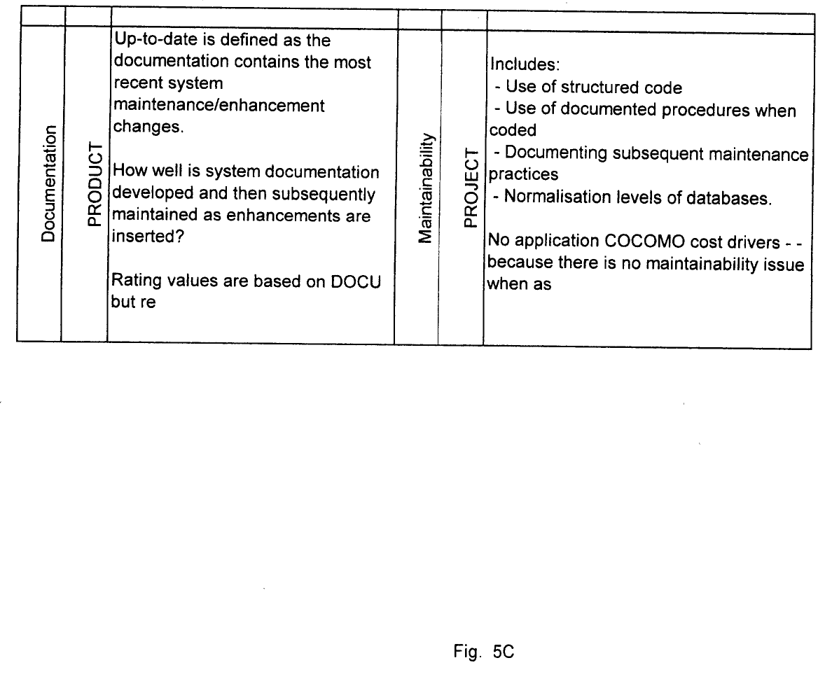

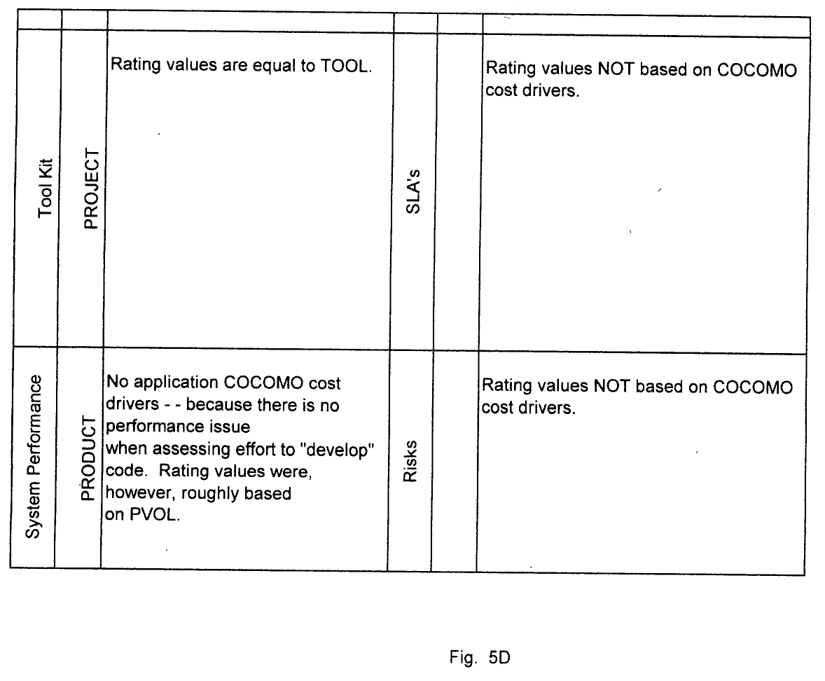

The ratings provided in FIGS. 4A-4R are conceptually based, in part, on COCOMO II cost drivers (e.g., product complexity [CPLX], platform volatility [PVOL], documentation [DOCU], multisite development [SITE], database size [DATA], applications experience [AEXP], platform experience [PEXP], language experience [LEXP] and software tools [TOOL]), as explained in FIGS. 5A-5D. For example, rating values for the interfaces attribute are based on CPLX, the product complexity COCOMO II cost driver.

Another important aspect of the present invention is that the attributes, sub-attributes and ratings in FIGS. 4A-4R, have been selected and empirically tailored for use in estimating software maintenance, rather than new software development. Thus, for example, while the preparation of detailed documentation increases the cost of software development, the absence of documentation increases the cost of maintenance. This is reflected in FIG. 4D by the rating (1.13) for the fourth attribute if documentation is unavailable. Further, good detailed documentation generally facilitates maintenance, resulting in a low rating. Additionally, certain attributes (e.g., maintainability) in FIGS. 4A-4R have no counterpart or equivalent for use with estimations for new software development.

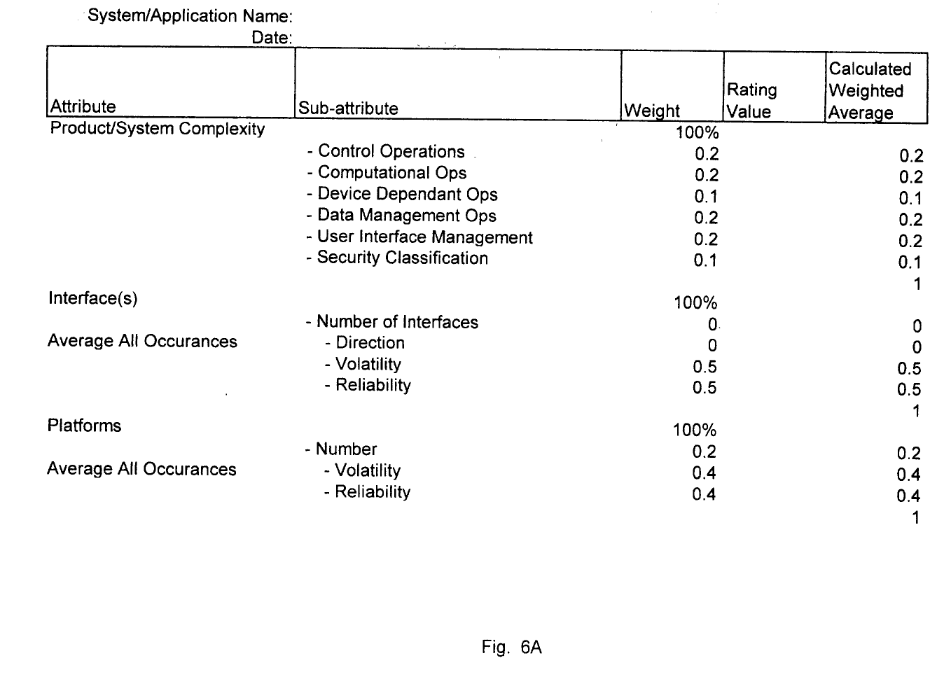

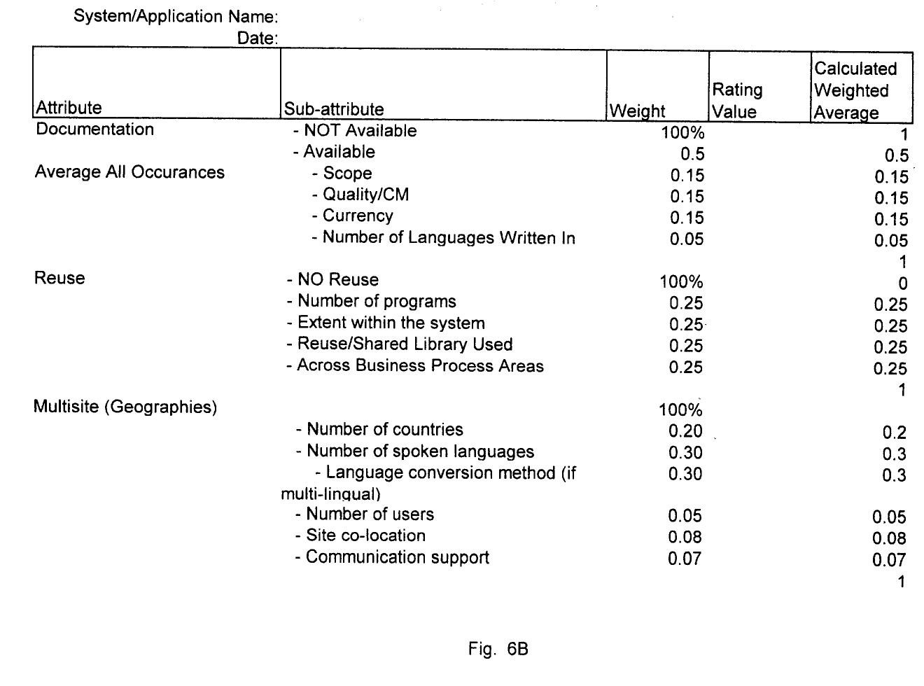

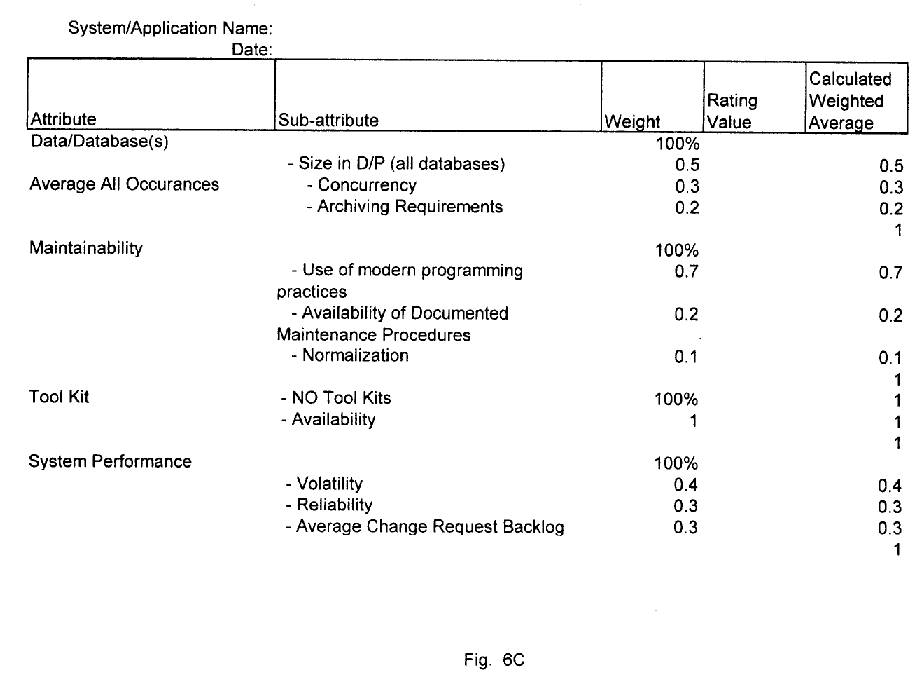

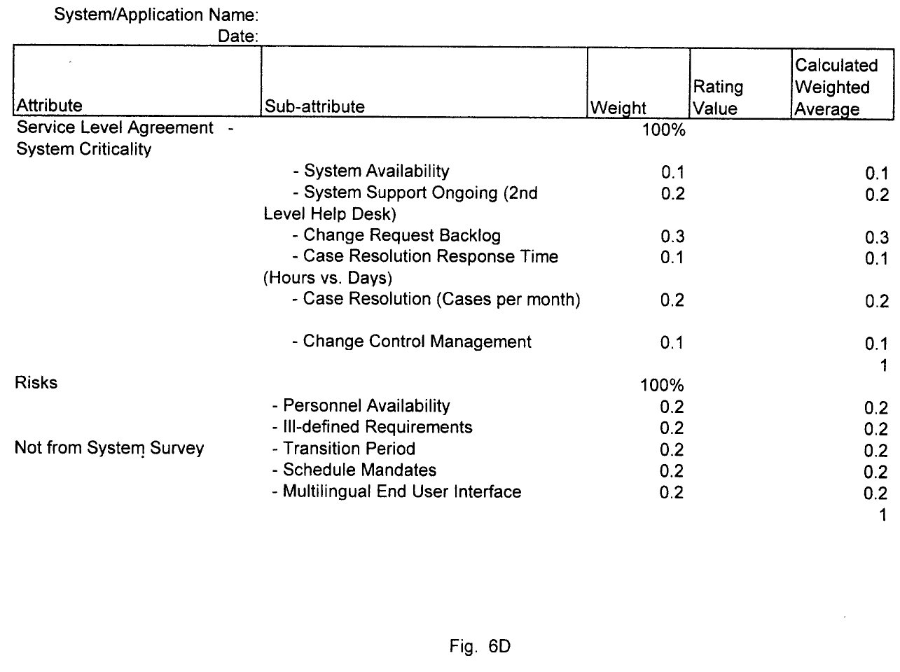

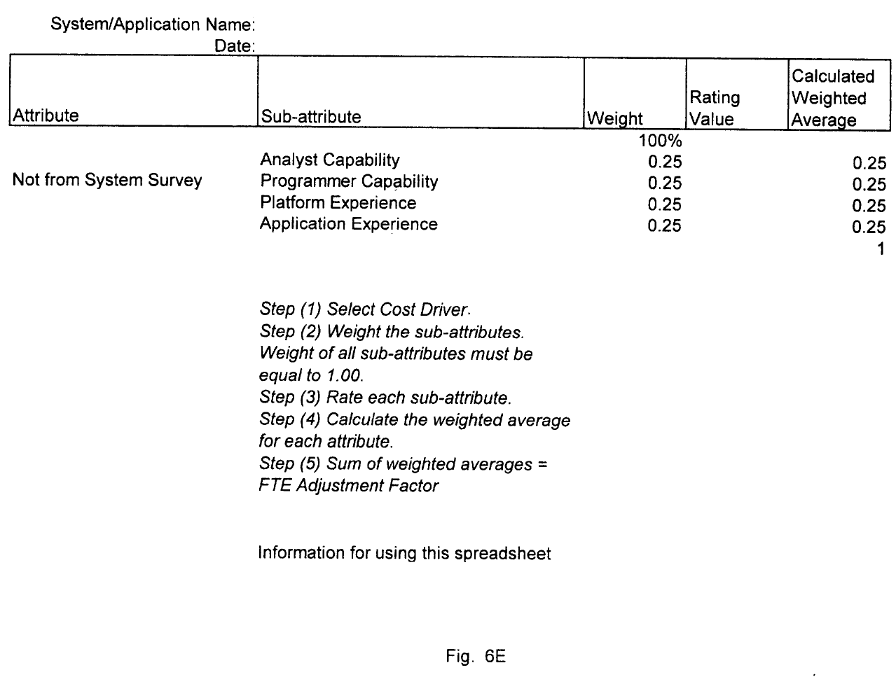

In calculating an effort multiplier, each sub-attribute (e.g., Control Operations, Computational Ops, Device Dependant Ops, Data Management Ops, User Interface Management and Security Classification) for an attribute (e.g., Product/System Complexity) is preferably weighted, such that the sum of the weights of the sub-attributes for an attribute equals one. Preferably, the weight for a sub-attribute is empirically determined based on its percentage impact to the attribute as a cost driver. FIGS. 6A-6E provide a preferred table of exemplary weights for the sub-attributes identified in FIGS. 5A-5D. Of course, weights may vary from one software system to another, depending upon the relative significance of a sub-attribute as a cost driver.

To calculate the effort multiplier based on the ratings and weights, a weighted rating is calculated for each sub-attribute. The weighted rating for a sub-attribute equals the product of the rating and the weight for that sub-attribute. Next, an attribute rating is calculated for each attribute by taking the sum of the weighted ratings for each corresponding sub-attribute. The effort multiplier equals the product of the attribute ratings for the attributes.

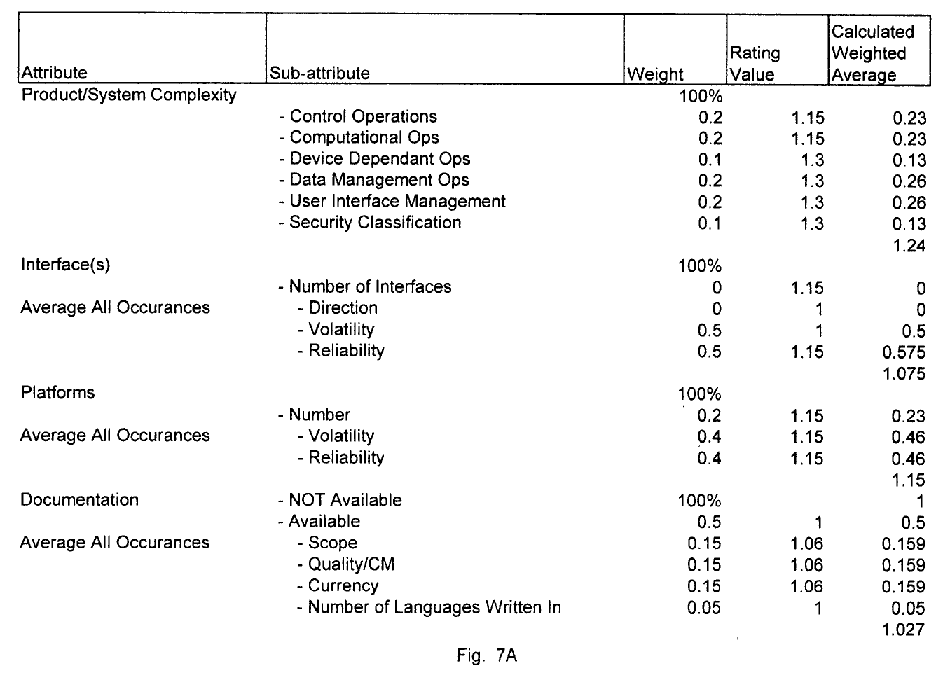

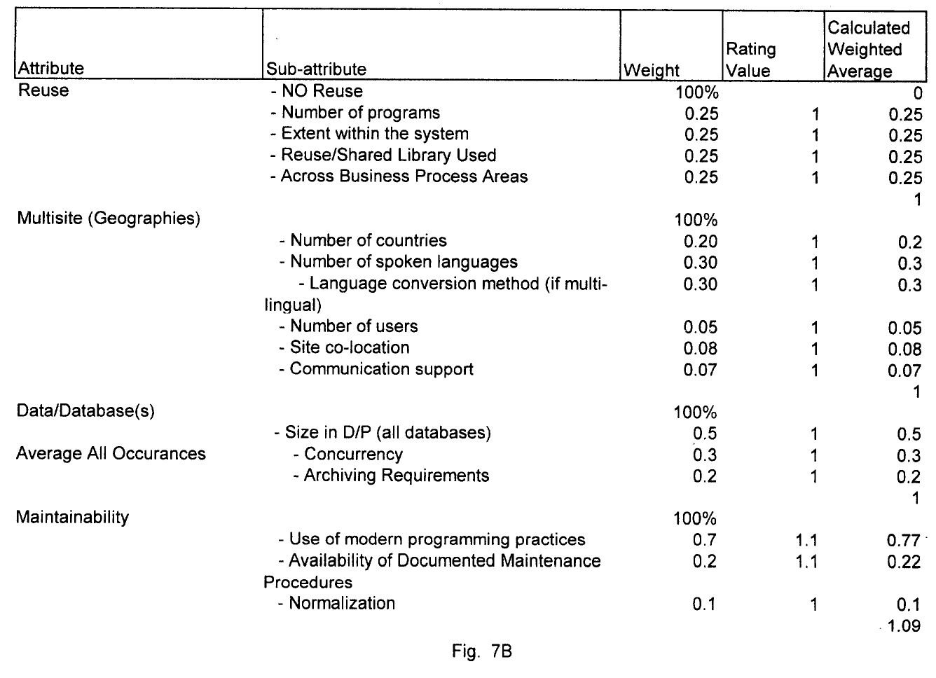

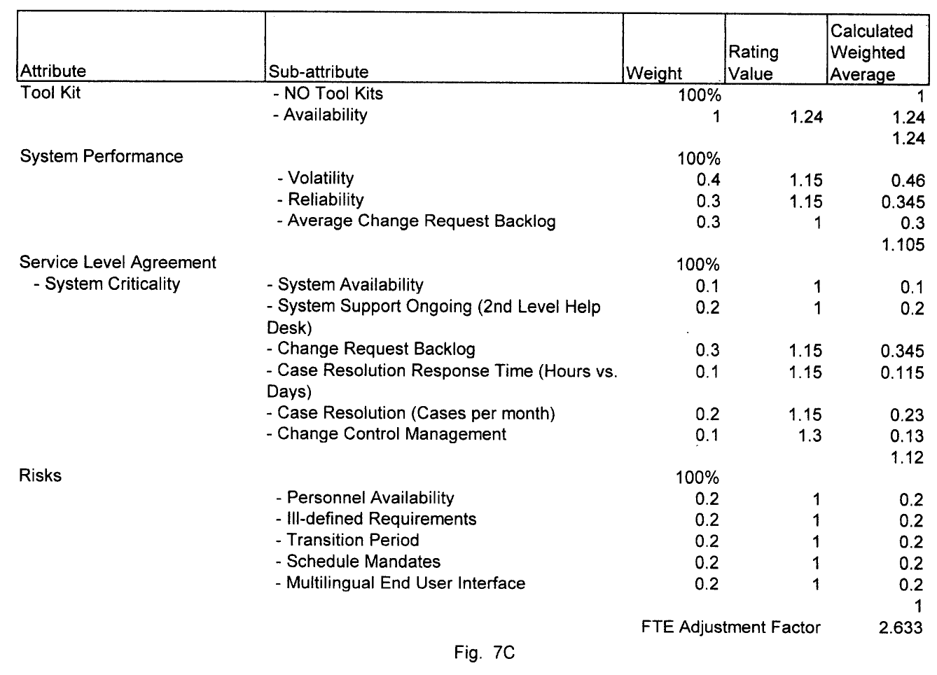

FIGS. 7A-7C illustrates a risk driven calculation of an effort multiplier for a hypothetical system in accordance with an exemplary implementation of the present invention. FIGS. 4A-4R and FIGS. 5A-5D define the attributes, sub-attributes and corresponding ratings. The ratings are determined according to the system's characteristics in relation to the attributes and sub-attributes. FIGS. 6A-6E provides the weight for each sub-attribute. The weighted rating for each sub-attribute equals the product of the weight and rating for that sub-attribute. The attribute rating for an attribute equals the sum of the weighted ratings for an attribute. Finally, the effort multiplier equals the product of the attribute ratings. In the example shown in FIGS. 7A-7C, the effort multiplier equals 2.633, indicating that the hypothetical system (because of its complexities) demands significantly more effort than the base effort.

Next, an adjusted effort, preferably in FTEs, is determined, as in step 260. The adjusted effort equals the product of the base effort, as determined in step 240, and the effort multiplier, as determined in step 250, as follows:

Adjusted Effort=Base Effort×Effort Multiplier

As an optional error check, the adjusted effort, as determined in step 260, may be compared with the current actual number of support FTEs, if such data is available. If the adjusted effort differs from the current actual number of support FTEs by more than a certain percentage, e.g., five percent (5%), then the attribute ratings and weights may be reviewed and verified. Additionally, the productivity level, as determined in step 230, may be reconsidered. If any changes are made, the sustainment baseline path (or the affected steps and all subsequent steps) may be performed again.

Next, cost is determined as in step 270. In a preferred implementation, a skill mix percentage is first determined, considering the skills required to support the system based on known system attributes. Some personnel attributes to consider in determining the skill mix include technical capability and experience, as well as knowledge of the applications, business, processes, platforms and toolkits. Selected billing rates may then be applied according to skill level. Project and management costs are then added, covering efforts such as program management, infrastructure, general and administrative costs, COTS software purchases, hardware purchases and training. The sum of these elements is the total price for maintenance.

Output from the sustainment baseline path may include any of the values determined in steps 210 through 270. Preferably, the output includes the base system size, maintenance productivity level, base effort, adjusted effort and the total price. This information enables the parties to objectively assess the complexity and size of the maintenance project, the productivity of the maintenance provider and the cost of maintenance.

While the present invention provides a tool for objectively quantifying maintenance, it is not a substitute for sound judgment. Accuracy of the results depends heavily on the quality of the input data. Results should be considered with this dependency in mind. Suspect results may warrant careful scrutiny of the input. Additionally, of course, important business decisions based on the results, e.g., contracting, budgeting, staffing and scheduling determinations, demand careful deliberation.

A preferred implementation of the present invention also includes a fast path for establishing a pool of available effort hours for performing maintenance tasks as the customer desires. The fast path provides an alternative funding method to a customer for tasks which are not clearly within the scope of system sustainment (which would be accounted for in the sustainment baseline path) or new development (which would be accounted for in the develop-enhance-retire path, as discussed below). When sustainment and development efforts are funded separately, and at different rates, defining a task as one or the other can become controversial. Offering the fast path with a preestablished number of hours as a third method can provide a mutually acceptable alternative. The fast path provides a quick and simple process for initiating and managing maintenance and related projects when controversy occurs over funding of the effort. The pool would be reestablished annually. As effort hours are performed the pool is depleted. Any funded hours remaining in the pool at the end of a contract year may be refunded to the customer.

The pool size for the fast path is established in one of three ways. The first way is simply an ad hoc basis. The second way is to establish the pool size is to base it on a high level review of any backlogged enhancements or developments. Based on high level statements of requirements for the backlogged items, estimates in hours for each item can be made. The estimated hours may then be divided or allocated over a period of years, such as the duration of a maintenance contract. The result may be the available fast path effort hours per year, which can be priced according to negotiated hourly rates and fees.

The third way to establish a fast path pool is based on the sustainment baseline path. The base system size may be multiplied by a selected percentage (e.g., 25%) to provide a function point size and proportionate adjusted number of hours for the fast path pool. The productivity level would be the same as calculated in the sustainment baseline path. The hours in the fast path pool may then be allocated over a period of time (e.g., in FTEs/yr), such as the duration of a maintenance contract. The result is the available fast path hours per year (e.g., in FTEs), which can be priced according to negotiated hourly rates and fees.

Any changes in system functionality as a result of a task funded through the fast path pool are factored into the sustainment baseline path. For example, the size (in function points) of a fast path enhancement may be added to the base system size as determined in step 220 of the sustainment baseline path. All subsequent steps of the sustainment baseline path may then be performed to take the new system size and attributes into account in recalculating the maintenance productivity level, base effort, adjusted effort and total price.

A preferred implementation of the present invention further includes a develop-enhance-retire path to help manage development, enhancement and retirement projects and account for attendant changes in system size. Application development, enhancement and retirement efforts may change the system size and consequently the effort to maintain the system. Changes may also affect the productivity of maintenance programmers and, consequently, the productivity level calculated in step 230 of the sustainment baseline path.

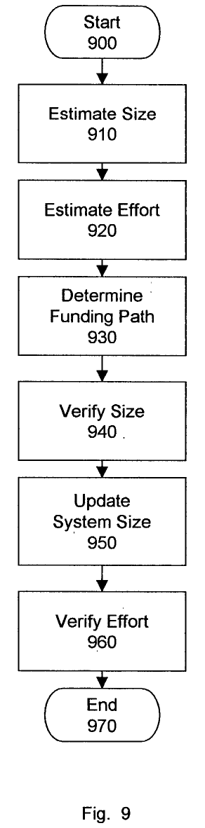

Referring to FIG. 9, the first step, step 910, of the develop-enhance-retire path is estimating size. Preferably the size is determined in function points using industry standard IFPUG function point counting practices that take into account application size and complexity as discussed above, without backfiring.

A preferred function point counting technique generally entails tallying an application's inputs, outputs, inquiries, external files and internal files. The information is typically obtained from detailed specifications and functional requirements documentation for the application being measured. Each tallied item is then weighted according to its individual complexity. The weighted sum of function points is then adjusted with a multiplier, decreasing, maintaining or increasing the total according to the intricacy of the system. The multiplier is based on various characteristics that evidence intricacy, such as complex data communications, distributed processing, stringent performance objectives, heavy usage, fast transaction rates, user friendly design and complex processing.

Next, the effort is estimated, as in step 920. The effort preferably equals an adjusted effort for the task, as calculated in steps 230 through 260 for the sustainment baseline path, as follows.

Adjusted Effort=Base Effort×Effort Multiplier

Where:

$$Base Effort = \frac{Software Size}{Productivity Level}$$

Productivity Level=Productivity level for task determined according to step 230 of the sustainment baseline path.

System size=Size for new/retired software determined according to step 220 of the sustainment baseline path. Typically expressed in function points (FPs).

Effort Multiplier=Effort multiplier for task determined according to step 250 of the sustainment baseline path.

After calculating the adjusted effort, a funding path is determined as in step 930. If the task will be funded through the fast path pool, the system size, or level of effort (e.g., in hours) or cost for the task is subtracted from the fast path pool. If the task is not funded through the fast path, it may be priced separately.

Upon completion of a development or enhancement task, a final system size is taken for the software as implemented, as in step 940. This final count is useful to account for scope creep caused by additional requirements and other unanticipated factors that could have affected original estimates. The final system size can be performed by the customer, maintenance provider or an independent third party.

Next, the size for the sustainment baseline path is adjusted, as in step 950. The system size of new or retired software is added to or subtracted from the base system size in the sustainment baseline path. A preferred implementation of the present invention further includes a trigger that would require all subsequent steps of the sustainment baseline path be then performed to take the new system size and attributes into account in recalculating the maintenance productivity level, base effort, adjusted effort and total price.

The effort (e.g., in hours) should also be verified, as in step 960. This verification accounts for changes in scope and inaccuracies of original estimates. Verification involves comparing the actual effort (e.g., in hours) with original estimates, and accounting for any differences.

In view of the foregoing, the present invention provides a system and method for accurately and consistently estimating effort and cost to maintain a single application, a group of applications or an aggregate system of applications. The backfiring technique, which correlates SLOC counts to function points, facilitates initial sizing of the system, without requiring extensive historical documentation that may not be available. To account for changes in size due to modifications as the system evolves after initial sizing, the present invention uses conventional sizing techniques, such as IFPUG function point counting practices. The present invention also accounts for the productivity of the maintenance staff in performing the full range of required maintenance tasks based, in part, on historical performance, experience or maturity level of the maintenance staff. The effort multiplier considers maintenance risks and complexities which may demand more than the average effort for a system of a given size and a maintenance staff having a certain productivity level. The present invention also provides a plurality of funding techniques to facilitate contracting.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

Having thus described the present invention, what is claimed as new and desired to be secured by Letters Patent is as follows:

1. A method for calculating an estimated effort to maintain a software system, said method including steps of:
determining a system size,
determining a productivity level,
determining an effort multiplier, and
determining the estimated effort, said estimated effort equaling the product of the effort multiplier and the system size divided by the productivity level.

2. A computer-implemented method for calculating an estimated effort to maintain a software system, said method including steps of:
determining a system size,
determining a productivity level,
determining an effort multiplier,
determining the estimated effort, said estimated effort equaling the product of the effort multiplier and the system size divided by the productivity level, and
storing the estimated effort in a memory of a computer.

3. The method for calculating an estimated effort to maintain a software system, according to claim 2, wherein the step of determining a productivity level further includes determining a productivity capability of a maintenance staff to perform the effort based on-experience of the maintenance staff and empirical data.

4. The method for calculating an estimated effort to maintain a software system, according to claim 3, wherein the step of determining an effort multiplier further includes:
determining ratings for a plurality of sub-attributes of the software system based upon empirical data, and
determining weights for the plurality of sub-attributes of the software system based upon empirical data, and
calculating a weighted rating for each sub-attribute of the software system, the weighted rating equaling the product of the weight and rating for the sub-attribute.

5. The method for calculating an estimated effort to maintain a software system, according to claim 4, wherein the step of determining a system size includes:
counting source lines of code by programming language for the software system, and
determining a system size in function points by backfiring the counted source lines of code.

6. The method for calculating an estimated effort to maintain a software system, according to claim 5, wherein the step of determining the productivity capability of a maintenance staff further includes:
determining average productivity ratios for a plurality of maintenance tasks comprising the maintenance effort,
calculating a plurality of weighted averages, each of said weighted averages equaling the product of each average productivity ratio and a weight, said weight equaling the estimated percentage each maintenance task comprises of the effort to maintain a software system, and
calculating the sum of the weighted averages,
determining a plurality of effort multipliers for personnel attributes of the maintenance staff,
determining an effort adjustment factor, said effort adjustment factor equaling the product of the effort multipliers, and
multiplying the sum of the weighted averages by the effort adjustment factor.

7. The method for calculating an estimated effort to maintain a software system, according to claim 6, wherein the step of determining a system size further includes updating the system size to account for changes in size over time.

8. The method for calculating an estimated effort to maintain a software system according to claim 7 wherein the step of determining a system size further includes updating system attributes and subattributes to account for changes in attributes and subattributes over time.

9. The method for calculating an estimated effort to maintain a software system, according to claim 7, wherein the software system includes a software application.

10. The method for calculating an estimated effort to maintain a software system, according to claim 9, wherein the software system includes a plurality of software applications.

11. The method for calculating an estimated effort to maintain a software system, according to claim 10, wherein the plurality of sub-attributes include the sub-attributes identified in FIGS. 4A-4R.

12. The method for calculating an estimated effort to maintain a software system, according to claim 11, wherein the ratings for the plurality of sub-attributes include the ratings identified in FIGS. 4A-4R.

13. The method for calculating an estimated effort to maintain a software system, according to claim 12, wherein the weights for the plurality of sub-attributes include the weights identified in FIGS. 6A-6E.

14. The method for calculating an estimated effort to maintain a software system, according to claim 13, wherein the plurality of tasks comprising the maintenance effort include the activities identified in FIG. 10.

15. The method for calculating an estimated effort to maintain a software system, according to claim 14, wherein the average productivity ratios for the plurality of tasks comprising the maintenance effort include the productivity ratios identified in FIG. 10.

16. The method for calculating an estimated effort to maintain a software system, according to claim 15, wherein the personnel attributes of the maintenance staff include the cost drivers identified in FIG. 8.

17. The method for calculating an estimated effort to maintain a software system, according to claim 16, wherein the plurality of effort multipliers for the personnel attributes include the effort multipliers identified in FIG. 8.

18. The method for calculating an estimated effort to maintain a software system, according to claim 17, further including the step of determining a price based on the calculated estimated effort.

19. The method for calculating an estimated effort to maintain a software system, according to claim 18, further including the step of adding a fast path price to the price determined in claim 17.

20. A system for calculating an estimated effort to maintain a software system, said system including:
means for determining a system size,
means for determining a productivity level,
means for determining an effort multiplier, and
means for determining the estimated effort, said estimated effort equaling the product of the effort multiplier and the system size divided by the productivity level.

21. A system for calculating an estimated effort to maintain a software system, according to claim 20, wherein the means for determining a productivity level further includes means for determining a productivity capability of a maintenance staff to perform the effort based on experience of the maintenance staff and empirical data.

22. A system for calculating an estimated effort to maintain a software system, according to claim 20, wherein the means for determining an effort multiplier further includes:
means for determining ratings for a plurality of sub-attributes of the software system based upon empirical data, and
means for determining weights for the plurality of sub-attributes of the software system based upon empirical data, and
means for calculating a weighted rating for each sub-attribute of the software system, the weighted rating equaling the product of the weight and rating for the sub-attribute.

23. A system for calculating an estimated effort to maintain a software system, according to claim 22, wherein the means for determining a system size includes:
means for counting source lines of code by programming language for the software system, and
means for determining a system size in function points by backfiring the counted source lines of code.
